(19) United States
(12) Patent Application Publication
(10) Pub. No.: US 2012/0106708 A1
(43) Pub. Date: May 3, 2012

(54) X-RAY IMAGING DEVICE WITH A C-SHAPED ARM AND AN ANTI-COLLISION UNIT

(76) Inventors: Yves Lucien Trousset, Palaiseau (FR); Bernard Bouvier, Eragny sur Oise (FR)

(21) Appl. No.: 13/269,785

(22) Filed: Oct. 10, 2011

(30) Foreign Application Priority Data
Oct. 29, 2010 (EP) 10306194.1

(51) Int. Cl. H05G 1/08

(52) U.S. Cl. 378/91

(57) ABSTRACT

The invention relates to a control process for a medical imaging device comprising an anti-collision unit, a source of X-rays, an image detector, a control unit for the source of X-rays and for the image detector. The process comprises determining at least one trajectory of the source of X-rays and of the image detector as a function of at least one previously fixed control parameter by means of the control unit, locating in space at least one object that may be on the at least one trajectory, and verifying that the at least one trajectory of the source of X-rays and the image detector will not risk a collision between the source of X-rays and the at least one object or the image detector and the at least one object.

### BACKGROUND OF THE INVENTION

1. Field of the Invention

The field of invention relates to X-ray medical imaging. More particularly, it relates to a control process for a medical imaging X-ray device comprising a source of X-rays and a detector, which may be connected by a C-arm, to avoid collisions between the environment of the imaging device and the source and/or the detector.

2. Description of Related Art

In medical imaging, a medical imaging device with a C-shaped arm (better known under the C-arm) is used to examine a patient. In fact, such a device produces images of the patient without requiring the patient to move.

FIG. 1 illustrates a medical imaging X-ray device 1 comprising a C-arm 2 on which there are arranged opposite one another an X-ray source 3 and a detector 4. The C-arm 2 is mounted on a support 5. The C-arm 2 can be moved in different directions D, D′ relative to the support 5. The medical imaging device 1 comprises a table 6 for receiving an object to be imaged, for example, a patient. The table 6 is placed on a base 7 and can be moved in several directions A, A′ relative to the base 7. During some types of image acquisitions from a patient, also called rotational acquisitions or 3D acquisitions, the C-arm is set in rotation around the patient by means of a control unit 8, and the rotation speed of the C-arm can be increased, according to need. So, the table 6 and the base 7 must be positioned correctly so that the C-arm 2 does not collide with the latter and if required with the patient and in general with the environment of the device.

To achieve this, prior to proceeding with acquisition as such, an operator performs a test rotation by controlling rotation of the C-arm at low speed to verify that there will be no collisions during the acquisition process. If test rotation indicates the possibility of a collision, the operator must then move the table 6 and recommence the test rotation. However, it is not easy for the operator to know what the minimum necessary displacement of the table 6 is in order to avoid a collision. If the operator shifts the table too far, the operator will definitely avoid the collision, but risks that the region of interest he wants to image is no longer present in the image. Another difficulty is that when shifting the table 6 to avoid a collision with one of the elements of the C-arm, for example the X-ray source 3, the operator can create a collision with another element, for example, the detector 4.

For these reasons, it is not uncommon in practice for the operator to have to make a number of test rotations (two, three or four) until an acceptable position for the table is found. The drawback in the known method is the prolonged duration of the acquisition procedure which is long and difficult for the operator such that, although having advantages in terms of acquisition, in the end, such medical imaging devices are not widely used.

### BRIEF SUMMARY OF THE INVENTION

An aim of the invention is to rectify the above drawbacks.

Therefore, according to a first aspect, the invention concerns control process for a medical imaging device comprising an anti-collision unit, a source of X-rays, an image detector, a control unit for the source of X-rays and for the image detector. The process comprises determining at least one trajectory of the source of X-rays and of the image detector as a function of at least one previously fixed control parameter by means of the control unit, locating in space at least one object that may be on the at least one trajectory, and verifying that the at least one trajectory of the source of X-rays and the image detector will not risk a collision between the source of X-rays and the at least one object or the image detector and the at least one object.

According to a second aspect, the invention concerns a medical imaging device comprising an X-ray imaging device comprising an X-ray source; an image detector; a control unit; and an anti-collision unit operably connected to the control unit and configured to determine at least one trajectory of the X-ray source and of the image detector as a function of at least one previously fixed control parameter by means of the control unit; locate in space at least one object that may be on the at least one trajectory; and verify that the at least one trajectory of the source of X-rays and the image detector will not risk a collision between the source of X-rays and the at least one object or the image detector and the at least one object.

With the process and device according to the first and second aspects of the invention, an operator can know in advance of a medical imaging procedure if the position of the objects situated in the environment close to the C-arm are going to cause collisions without having to conduct a rotation test. The invention thus reduces the duration of medical imaging acquisition procedures that use a medical imaging device comprising a C-arm, which in turn makes it more attractive beyond the advantages in performance.

### BRIEF DESCRIPTION OF THE SEVERAL VIEWS OF THE DRAWINGS

The embodiments of the invention may be best understood by reference to the following description taken in conjunction with the accompanying drawing figures in which:

FIG. 1 illustrates a known medical imaging X-ray device;

FIG. 2 illustrates a medical imaging device according to an embodiment of the present invention;

FIG. 3 illustrates three possible three-dimensional trajectories for the C-arm of the medical imaging device according to an embodiment of the present invention;

FIG. 4 illustrates a bidimensional view of a table for supporting an object to be imaged by means of a medical imaging device according to an embodiment of the present invention;

FIG. 5 schematically illustrates a control process for a medical imaging device according to an embodiment of the present invention.

### DETAILED DESCRIPTION OF THE INVENTION

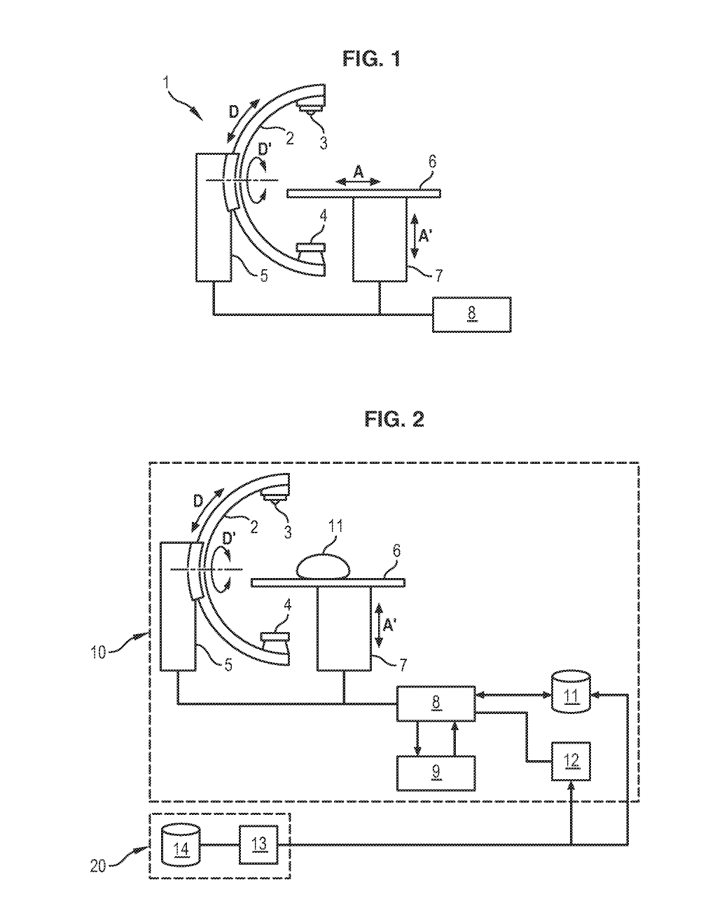

FIG. 2 illustrates a medical imaging device 10 comprising, apart from elements illustrated in FIG. 1, an anti-collision unit 9 configured to run a control processor of the medical imaging device 10 and, in particular, to determine a trajectory of the C-arm 2 and determine the position of at least the table 6 relative to the trajectory thus determined.

The anti-collision unit 9 is connected to the control unit 8 of the medical imaging device 10. The connection can be wire or wireless. The anti-collision unit 9 can be for example a computer or computers, a processor or processors, a microcontroller or microcontrollers, a microcomputer or microcomputers, a programmable automaton or automatons, a specific integrated application circuit or integrated application circuits, other programmable circuits or other devices which include a computer such as a workstation.

The detector 4 can be a semi-conductor image sensor comprising, for example cesium iodide phosphorous (scintillater) on a matrix of transistor/photodiode in amorphous silicon. Other adequate detectors are: a CCD sensor, a direct digital detector which directly converts X-rays into digital signals. The detector 4 illustrated in FIG. 2 is flat and defines a flat image surface, and other geometries can also be suitable.

As already mentioned, the control unit 8 controls acquisition specifically by fixing several parameters such as radiation dose to be emitted by the X-ray source 3 and positioning of the source 3 and of the detector 4. The control unit 8 may be connected to the support 5 of the C-arm 2 by wire or wireless connection.

The control unit 8 can comprise a reader (not shown) for example a disc reader, a CD-ROM, DVDROM reader, or connection ports for reading the instructions of the treatment process of an instruction medium (not shown), such as a disc, a CD-ROM, DVD ROM, or USB key or more generally by any removable storage means or even via a network connection.

A storage unit 11 is also provided for recording acquisition parameters. It is possible to ensure that the storage unit 11 is situated inside the control unit 6 or outside it. The storage unit 11 can be formed by a hard drive or SSD, or any other removable and rewritable storage means (USB keys, memory cards etc.). The storage unit 11 can be ROM/RAM memory of the control unit 8, a USB key, a memory card, memory of a central server.

The imaging device also comprises a display unit 12 connected to the control unit 8 for displaying images acquired by the imaging device and/or information on acquisition control parameters and/or on information originating from the anti-collision unit 9. The display unit 12 can be for example a computer screen, a monitor, flat screen, plasma screen or any other type of display device of known type.

The medical imaging device 10 is coupled to a processing system 20. The processing system 20 comprises a calculation unit 13 and storage unit 14. The processing system 20 receives images acquired and stored in the storage unit 11 of the medical imaging system 10 from which it makes a certain number of processing actions, for example reconstruction of a 3D image from 2D images. Also, the processing system 20 further comprises a storage unit 14 for storage of data generated by the calculation unit 9. Also, the processing unit 20 can be included in the medical imaging device 10; their respective storage units 11, 14 therein are combined.

Transmission of data from the storage unit 11 of the medical imaging device 10 to the calculation unit 13 of the processing system 20 can be done over an internal or external digital network or by way of any adequate physical memory medium such as diskettes, CD-ROM, DVD-ROM, external hard drive, USB key, SD card, etc.

The calculation unit 13 is for example a computer or computers, a processor or processors, a microcontroller or microcontrollers, a micro-computer or micro-computers, a programmable automaton or automatons, a specific integrated application circuit or integrated application circuits, other programmable circuits or other devices which include a computer such as a workstation. The calculation unit 13 can be connected to the display unit 12 (as in FIG. 2) or else to another display unit (not shown).

By way of variant, the calculation unit 13 can further comprise a reader (not shown) for example a disc reader, a CD-ROM or DVD-ROM reader, or connection ports for reading the instructions of the treatment process of an instruction medium (not shown), such as a diskette, a CD-ROM, a DVD-ROM or a USB key or more generally by any removable memory medium or even via a network connection.

The control process for the medical imaging device 10 verifies, without having to control rotation of the source and of the detector, that there will be no collisions between at least the table 6 and the detector 4 and/or the table 6 and the source 3 of X-rays. As already mentioned, the source 3 and the detector 4 can be connected by a arc 2, in which case it is the trajectory of the C-arm 2 which is considered.

The control process for the medical imaging device comprises: determining 100 at least one trajectory of the source of X-rays and of the image detector as a function of at least one previously fixed control parameter by means of the control unit, locating 200 in space at least one object that may be on the at least one trajectory, and verifying 300 that the at least one trajectory of the source of X-rays and the image detector will not risk a collision between the source of X-rays and the at least one object or the image detector and the at least one object.

The different steps of the process are explained hereinbelow.

The trajectory may be determined as a function of the parameters of the device necessary for acquisition of images of the control unit 8: position of the source 3, of the detector 4, of the C-arm 2 if needed, in the space.

It is evident that the position of the source and of the detector relative to the table 6 is conditioned by the position of an object 11 to be imaged, a patient in practice, lying on the table 6.

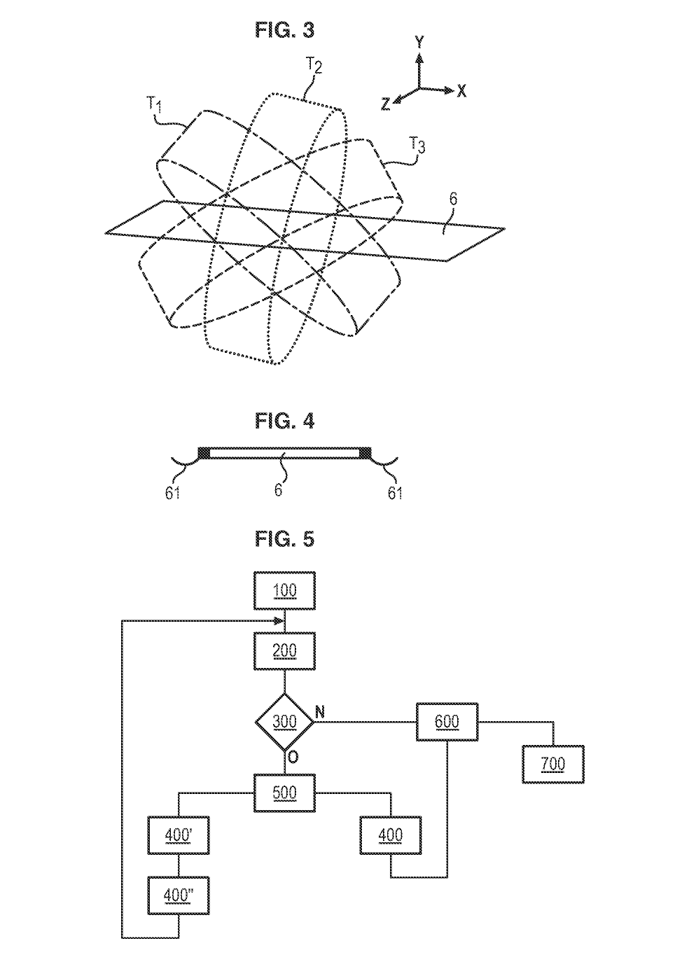

The simplest and most used trajectory of the source and of the detector is when they are connected by a C-arm 2 and is such that the source of X-rays 3 shifts according to an arc of a circle, as illustrated in FIG. 3 where three trajectories T1, T2, T3 of the C-arm 2 are represented.

Other more complex trajectories such as the following are likewise feasible: source of X-rays 3 moving according to a first arc of a circle in a first plane, followed by a second arc of a circle in a second plane, or else a source of X-rays 3 moving according to a non-circular trajectory (such as elliptical trajectory, non-planar trajectory, etc).

It is specified that an object to be located means any object situated near the device or which evidently can be on the trajectory of the C-arm 2.

It can be the table 6 for supporting a patient, the base 7 supporting the patient, the patient herself or even monitors used for assisting a practitioner, a trolley for supporting a user interface which controls the imaging device, accessories for holding the patient on the table, such as armrest or headrest, and finally various devices such as tables for placing medical instruments, anaesthesia trolleys, etc. FIG. 5 illustrates the table 6 comprising media 61 for the arms of a patient, for example.

Several means known to the expert are used to locate 200 in the space at least one of the objects already mentioned such as locating the table 6 in a known manner by electro-mechanical sensors (encoders, potentiometers, etc). A sensor for detecting the presence or absence of an accessory such as armrest or headrest may also be used. Position sensors of the electromagnetic or optical type, arranged on each of the elements such as monitors, anaesthesia trolleys, etc, may also be used. Capacitive sensors which measure the distance between the sensor and the closest object may also be used. These various sensors detect all materials, they function without contact with the material whereof the proximity to the sensor is to be evaluated and they are resistant to wear. They can be used in particular for determining the exact position and the envelope of the patient 11 on the table 6. With this aim, these sensors can be fixed on the detector 4, for example. They can likewise be used for determining the presence or absence of objects near the C-arm.

Verification 300 consists of verifying the determined trajectory with with respect to the one or more located objects to be detected and verifying if, during operation, the source 3 and the detector 4 describing the determined trajectory risk colliding with one or more located objects. More precisely, during this verification step, the located object or objects will correspond with the determined trajectory described by the source 3 and the detector 4 to verify where the located object or objects are relative to the determined trajectory. In fact, it is possible to carry out this verification 300 from the determined trajectory and the coordinates of the located object or objects.

In the event where verification 300 is positive, that is, that a collision is possible between the located object or objects and the source 3 of X-rays and/or the detector 4, the process further comprises determining 400 positioning parameters of one or more located objects such that the source and the detector describing the determined trajectory do not collide with the object.

As a variant, if verification of the collision is positive, the process may further comprise indicating 400 that one or more objects are on the trajectory, a step consisting of moving 400″ the indicated object or objects and repeating the locating 200 and verification 300 steps with the position of the displaced object or objects. The step consisting of moving 400″ the indicated object or objects can be automated. In this variant, in real time, it is therefore possible to know if the displaced object is going to cause a collision. Visual or audio alert means to indicate the status of the verification step 300 is feasible.

It is feasible to display 500 on a display device an alert message of the “collision” type while the verification 300 is positive and displays 600 an alert message of the “no collision” type when verification 300 is negative. In the event where verification 300 proves negative, that is, that no collision is possible between the object or the located objects and the source 3 of X-rays and/or the detector 4, the process further comprises a step consisting of displaying that the control parameters of the medical imaging device are correct.

Finally, the process comprises a step during which the C-arm is set in rotation 700 as a function of the verified parameters.

What is claimed is:

1. A control process for a medical imaging device comprising an anti-collision unit, a source of X-rays, an image detector, a control unit for the source of X-rays and for the image detector, the process comprising:
determining at least one trajectory of the source of X-rays and of the image detector as a function of at least one previously fixed control parameter by means of the control unit;
locating in space at least one object that may be on the at least one trajectory; and
verifying that the at least one trajectory of the source of X-rays and the image detector will not risk a collision between the source of X-rays and the at least one object or the image detector and the at least one object.

2. The control process according to claim 1, further comprising determining positioning parameters of the at least one object such that the source of X-rays and the image detector do not collide with the object when verifying indicates a risk of such a collision.

3. The control process according to claim 1, further comprising: indicating that the at least one object is on the trajectory; moving the at least one object; and repeating the locating and verifying steps when verifying indicates a risk of a collision between the source of X-rays and the at least one object or the image detector and the at least one object.

4. The control process according to claim 1, further comprising indicating that the control parameters are incorrect when verifying indicates a risk of a collision between the source of X-rays and the at least one object or the image detector and the at least one object.

5. The control process according to claim 1 further comprising indicating that the control parameters are correct when verifying does not indicate a risk of a collision between the source of X-rays and the at least one object or the image detector and the at least one object.

6. The control process according to claim 1, wherein determining the at least one trajectory is at a different speed than a speed used when the medical imaging device acquires images.

7. The control process according to claim 1 in which the at least one trajectory is determined from a cylindrical trajectory model.

8. An X-ray imaging device comprising
an X-ray source;
an image detector;
a control unit; and
an anti-collision unit operably connected to the control unit, wherein the anti-collision unit is configured to determine at least one trajectory of the X-ray source and of the image detector as a function of at least one previously fixed control parameter by means of the control unit; locate in space at least one object that may be on the at least one trajectory; and verify that the at least one trajectory of the source of X-rays and the image detector will not risk a collision between the source of X-rays and the at least one object or the image detector and the at least one object.

9. The X-ray imaging device according to claim 8 further comprising a C-arm, wherein the image detector detector and the X-ray source are arranged at opposite ends of the C-arm.
